(19) United States
(12) Patent Application Publication
(10) Pub. No.: US 2025/0378082 A1
(43) Pub. Date: Dec. 11, 2025

(54) TRANSFORMING DATA FORMS IN SCHEMAS

(71) Applicant: DevRev, Inc., Palo Alto, CA (US)

(72) Inventor: Lorinc András Bódy, Ljubljana (SI)

(73) Assignee: DevRev, Inc., Palo Alto, CA (US)

(21) Appl. No.: 18/739,574

(22) Filed: Jun. 11, 2024

(51) Int. Cl. G06F 16/25; G06F 16/21

(52) U.S. Cl. CPC G06F 16/258; G06F 16/211

(57) ABSTRACT

Techniques for transforming data forms in schemas are described. A first data from a source platform is received. The first data is in a first data schema, which is in a raw form that corresponds to the first data having an additional structure. The additional structure enables transformation of the first data into a format compatible with a second platform. The received first data is processed using a transformation function. The received first data is converted into a transformed form. The transformed form is in a first transformed schema that is compatible with the second platform. The received first data in the first data schema, the transformation function, the transformed form of the received first data are stored in a memory.

### BACKGROUND

Conventionally, companies or organizations have software-based applications, such as Customer Relationship Management (CRM) based software applications for various purposes. For instance, an organization has CRM-based software applications to address concerns of the customer about a product or a service provided by the organization, to market their product to new customers, handling customer sales using billing systems, and the like. The CRM-based software applications may exchange data with other software-based applications for smooth and consistent flow of data. For instance, there may be data transfer from an e-mail marketing platform to the CRM-based software application regarding marketing the product or service of the organization to a new customer.

### BRIEF DESCRIPTION OF DRAWINGS

The detailed description is provided with reference to the accompanying figures. In the figures, the leftmost digit(s) of a reference number identifies the figure in which the reference number first appears. The same numbers are used throughout the drawings to reference like features and components.

FIG. 1a illustrates a system to transform data forms in schemas for data transfer between different platforms, according to an example implementation of the present subject matter.

FIG. 1b illustrates a system to transform data forms in schemas for data transfer between different platforms, according to an example implementation of the present subject matter.

FIG. 2 illustrates a method to transform data forms in schemas for data transfer between different platforms, according to an example implementation of the present subject matter.

FIG. 3 illustrates a method to transform data forms in schemas for data transfer between different platforms, according to an example implementation of the present subject matter.

FIG. 4 illustrates a method to transform data forms in schemas for data transfer between different platforms, according to an example implementation of the present subject matter.

FIG. 5 illustrates a method to transform data forms in schemas for data transfer between different platforms, according to an example implementation of the present subject matter.

FIG. 6 illustrates a method to transform data forms in schemas for data transfer between different platforms, according to an example implementation of the present subject matter.

FIG. 7 illustrates a method to transform data forms in schemas for data transfer between different platforms, according to an example implementation of the present subject matter, and

FIG. 8 illustrates a computing environment, implementing a non-transitory computer-readable medium for transformation of data forms in schemas for data transfer between different platforms, according to an example implementation of the present subject matter.

Throughout the drawings, identical reference numbers designate similar elements, but may not designate identical elements. The figures are not necessarily to scale, and the size of some parts may be exaggerated to illustrate the example shown with better clarity. Moreover, the drawings provide examples and/or implementations consistent with the description; however, the description is not limited to the examples and/or implementations provided in the drawings.

### DETAILED DESCRIPTION

Conventionally, organizations use Customer Relationship Management (CRM) system to manage customer and client relationships. The CRM system may transmit or receive data for various purposes, such as to store a record about a client for a business, to address a problem raised by a user corresponding to a product or a software application of the business, to expand the customers of the business, and the like. Generally, the CRM system may have to be connected to various software applications, databases, Information Technology systems (IT systems), and one or more external CRM systems for optimizing the data flow across various platforms. For example, the CRM system may be connected to e-mail marketing platform, accounting software platform, sales data platform, and the like. This may ensure that the data is consistent and easily accessible throughout the organization. In this regard, the CRM system may receive data from one or more external platform. For instance, data corresponding to a client for a business may have to be integrated from an external CRM system.

Generally, for the data transfer and interchange with the CRM system, various data formats are used. Particularly, common data format in which the data transfer is done is JavaScript Object Notation (JSON) format. Data within the data format have a shape which is described by a schema. In other words, the schema describes, for example, keys that can exist, keys that must exist, valid data types, length of arrays, or strings, or the like, within the data format. For example, data within JSON format is described by a JSON-schema or a fern definition. The JSON schema or a fern definition describes keys that can and must exist for JSON format, valid data types for JSON format, length of data types for JSON format, and the like.

During data integrations for CRM systems, the schemas are used to describe data from external platforms that are integrated into the CRM systems. Specifically, in the CRM system, the schemas are used to derive transformation of data into a format compatible or understandable by the CRM system in a low-code way. However, conventionally, the external data does not have a proper structure often and has extra structure in it. In addition, the external data is not well-expressed in terms of the shape of the data format it is defined in. For instance, if format of the external data is JSON, the external data has extra structure in it and not well-expressed in terms of the JSON shape of the data. In an exemplary scenario, some external platforms store and return multi-select fields embedded in a single string with a separator, such as a semi-colon separator. For instance, assume that the multi-select field has selected options “first”, “second”, and “fourth”. The external platform may return as “first; second; fourth”. In another example, some platforms encode numbers as strings. For instance, the value returned may be, for example, “1.3213”. In some scenarios, JSON data format or other structured formats are arranged into a string and embedded directly into some fields. In some other scenarios, JSON data format or other structured formats are embedded encoded into some fields in a binary-to-text encoding scheme, such as a base64 scheme. To align the data from another platform into a format understandable by the platform into which the data is integrated, manual intervention is necessary. This makes the process of data integration cumbersome and difficult. Particularly, data integration becomes further difficult when data is to be integrated from multiple external platforms. Conventional schemas do not provide a way to express the properties of data in a more natural representation. In other words, conventionally, schemas are proscriptive. Further, conventionally, schemas do not allow a low-code system to take advantage of the schemas to transform them to a more natural representation. For instance, the natural representation of an array of strings could be an array instead of a single string with a separator. Accordingly, conventionally, data integration from one platform to another platform is difficult.

The present subject matter is related to transforming data forms in schemas. With the present subject matter, data is transformed from a raw format into a more natural format that is compatible with a destination platform into which the data has to be integrated into. Further, with the present subject matter, data integration from a source platform into a destination platform is easier and simpler. Even if data may have to be integrated from a plurality of source platforms into a destination platform, the present subject matter enables easy, efficient, and simpler integration of data.

In an implementation, a system may transform data forms in schemas for data transfer between different platforms and may include a memory and a processing unit. The processing unit may be coupled to the memory. The processing unit may receive a first data from a source platform. The source platform may be a platform from which the data is to be integrated into a second platform. For instance, the source platform may be a first Customer Relationship Management (CRM) platform from which one or more data are to be integrated into a second CRM platform. The data may be in a first data schema. The first data schema may define structure of the first data. The first data schema may be in a raw form which corresponds to the first data having an additional structure. The additional structure may enable transformation of the first data into a format compatible with the second platform. For instance, the first data may be a multi-select fields embedded in a single string with a separator, such as a semi-colon separator. The example value corresponding to the first data schema may be, for example, “first; second; third”. Here, the semi-colon separator is the additional structure that may enable transformation of the first data into a format compatible with the second platform.

Further, the received first data may be processed using a transformation function. The transformation function may be embedded in the first data schema and may be defined in a high-level programming language. The transformation function may correspond to a deterministic function. For instance, if an example value corresponding to the first data schema is “first; second; third”, the transformation function may be split function based on semicolon. The high-level programming language may be Javascript, jq, python, rego, c compiled to webassembly, java, haskell, and rust.

Accordingly, the received first data may be converted into a transformed form using the transformation function. The transformed form may be in a first transformed schema. The first transformed schema may be compatible with the second platform. For instance, upon applying the transformation function, the data may be split as “first”, “second”, and “third”, which may represent the first transformed schema that is compatible with the second platform. Further, the received first data in the first data schema, the transformation function, the transformed form of the received first data may be stored in a memory. This may be performed for a subsequent validation and/or analysis.

In another example, a second data may be received from the source platform. The source platform may be the same source platform or another source platform. The data may be in a second data schema. The second data schema may define structure of the second data. The second data schema may be in a raw form that corresponds to the second data having an additional structure. The additional structure may enable transformation of the second data into a format compatible with the second platform. The transformation function may be applied on the second data to obtain a transformed form. The transformed form may be in a second transformed schema. The second transformed schema may be compatible with the second platform. The second data may be similar to the first data.

The second transformed schema may be determined. The first transformed schema may be merged with the second transformed schema to obtain a merged transformed schema. The merging may be done using a first model. The first model may be, for example, a merging algorithm. Further, the second transformed schema may be annotated with the merged transformed schema and the transformation function.

In another example, a second data may be received from the source platform. The data may be in a second data schema that defines structure of the second data. The second data schema may be in a raw form that correspond to the second data having an additional structure. The additional structure may enable transformation of the second data into a format compatible with the second platform. The transformation function is applied on the second data. In an example, the transformed form of the second data is not obtained if the application of the transformation function fails. The application of the transformation function may, for example, fail if the second data is not similar to the first data.

In another example, a second data may be received from the source platform. The data may be in a second data schema. The second data schema may define structure of the second data and may be being in a raw form. The raw form of the second data may correspond to the second data having an additional structure. The additional structure may enable transformation of the second data into a format compatible with the second platform. The second data may be processed using the transformation function. The second data may be transformed into a transformed form with the transformed form being in a second transformed schema. The second transformed schema may be compatible with the second platform. The first data and second data may be merged to form a union of the first data and the second data. The union of the first data and the second data may correspond to data including the first data, the second data, or combination thereof.

The union of the first data and the second data may be converted into a transformed form. The transformed form may be in a third transformed schema that is compatible with the second platform. The third transformed schema may be a union of the first transformed schema and the second transformed schema. The union of the first transformed schema and the second transformed schema may correspond to the first transformed schema, the second transformed schema, or combination thereof.

In yet another example, a second data may be received from the source platform. The second data may be in a second data schema. The second data schema may define structure of the second data. The second data schema may be in a raw form that corresponds to the second data having an additional structure. The additional structure may enable transformation of the second data into a format compatible with the second platform. The second data may be transformed using a transformation function. The second data may be converted into a transformed form that is in a second transformed schema. The second transformed schema may be compatible with the second platform. The first data and second data may be combined to form an intersection of the first data and the second data. The intersection of the first data and the second data may correspond to data overlap between the first data and the second data. Further, the intersection of the first data and the second data are converted into a transformed form that is in a fourth transformed schema. The fourth transformed schema may be compatible with the second platform. The fourth transformed schema may be an intersection of the first transformed schema and the second transformed schema. The intersection of the first transformed schema and the second transformed schema may correspond to data overlap between the first transformed schema and the second transformed schema.

With the present subject matter, data is transformed from a raw format into a more natural format that is compatible with a destination platform into which the data has to be integrated into. Further, with the present subject matter, data integration from a source platform into a destination platform is easier and simpler. Even if data may have to be integrated from a plurality of source platforms into a destination platform, the present subject matter enables easy, efficient, and simpler integration of data. In the present subject matter, the transformed schemas are in natural form and are in descriptive language. In other words, in the present subject matter, the schemas are self-describing with no special format names. Accordingly, with the present subject matter, the schema of the source platforms that is being described by transformed forms are more granularly described. The present subject matter enables actionable transformation to transform the received data from the source platforms. Further, the present subject matter enables to recover validation by transforming the received data into a transformed form and validating output of the received data against schema of the output in the transformed form. The present subject matter is actionable without human intervention or Artificial intelligence intervention for the data integration into a destination platform.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

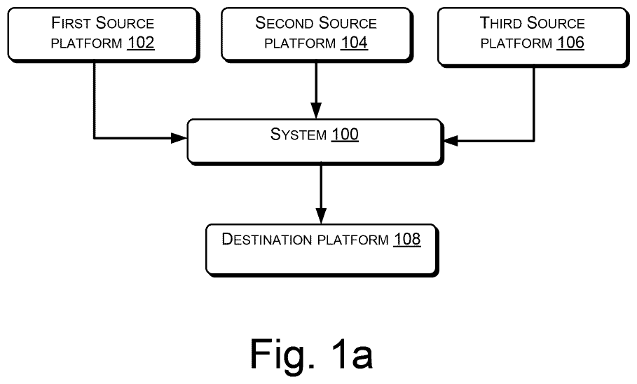

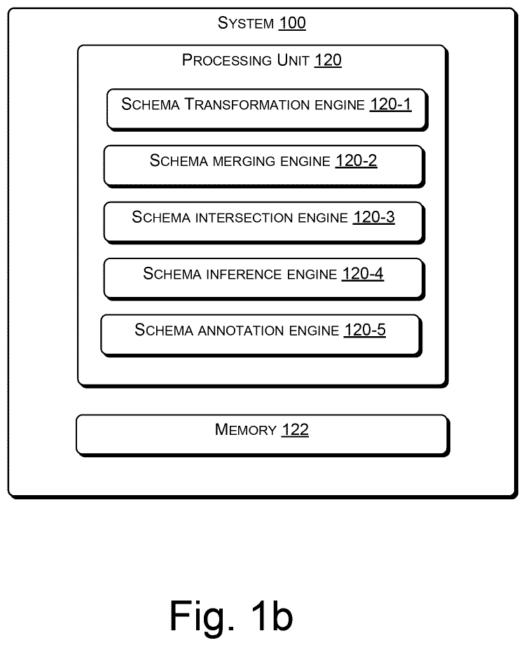

FIG. 1a illustrates a system 100 to transform data forms in schemas for data transfer between different platforms, according to an example implementation of the present subject matter. Systems, such customer relationship management (CRM) systems, may integrate data for different purposes, such as to send marketing e-mails to prospective customers, to solve issues raised by customers about the CRM system, and the like. Accordingly, the CRM systems may be connected to various software applications, platforms, databases, one or more CRM systems, and the like. In this regard, the CRM systems that are to transmit the data may be referred to as the first platforms, such as the first source platform 102, the second source platform 104, and the third source platform 106. The first source platform 102 may be, for example, a CRM system. The second source platform 104 may be, for example, an e-mail marketing platform. The third source platform 106 may be, for example, accounting software platform. The data from the source platforms 102, 104, 106 may have to be integrated into a second platform, such as a destination platform 108. The destination platform 108 may be, for example, a CRM system.

The data transmitted by the source platforms 102, 104, 106 may be in a format that is not compatible with the destination platform 108. The data may be in a particular data schema. The data schema described shape of the data and provide a format for what data is required for a given application and how to interact with the data. The data schema may include different keys and properties of the data. For instance, assume that the source platform 102 transmits a data corresponding to multi-select fields in a data schema embedded in a single string with a separator, such as “first; second; fourth”. However, such data schema may not be read by the destination platform 108 as a multi-select fields. In this regard, the data transmitted by the source platforms 102, 104, 106 may be transformed in a schema compatible with the destination platform 108 by the system 100. The system 100 may receive the data from various source platforms 102, 104, 106 and transmit data transformed into a schema compatible with the destination platform 108 to the destination platform 108.

Although in the above example, the system 100 is depicted to be external to or outside of the destination platform 108, in some examples, the system 100 may be part of the destination platform 108.

FIG. 1b illustrates the system 100 to transform data forms in schemas for data transfer between different platforms, according to an example implementation of the present subject matter. The system 100 may be a computing device that has processing capabilities, such as a server, a desktop, a laptop, a tablet, a mobile phone, or the like. For instance, the system 100 may include, for example, a microprocessor, a microcomputer, a microcontroller, a digital signal processor, a central processing unit, a state machine, a logic circuitry, or a device that manipulates signals based on operational instructions. The system 100 may include a processing unit 120 and a memory 122. Among other capabilities, the processing unit 120 may fetch and execute computer-readable instructions stored in the memory 122, such as a volatile memory or a non-volatile memory, of the device.

The processing unit 120 may run at least one operating system and other applications and services. The system 100 may also include an interface (not shown in FIG. 1b) and a memory (not shown in FIG. 1b). The processing unit 120, amongst other capabilities, may be configured to fetch and execute computer-readable instructions stored in the memory 122. The processing unit 120 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 120, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

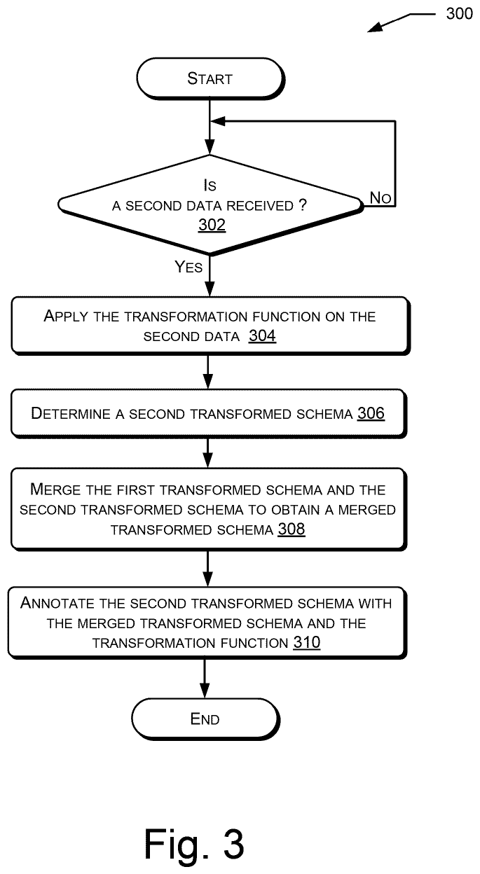

The interface may include a variety of machine-readable instructions-based interfaces and hardware interfaces that allow the system 100 to interact with different entities, such as the source platforms 102, 104, 106, the destination platform 108, and the data (not shown in FIG. 3). Further, the interface may enable the components of the system 100 to communicate with computing devices, web servers, and external repositories. The interface may facilitate multiple communications within a wide variety of networks and protocol types, including wireless networks, wireless Local Area Network (WLAN), RAN, satellite-based network, and the like.

The memory 122 may be coupled to the processing unit 120 and may, among other capabilities, provide data and instructions for generating different requests. The memory 122 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the system 100 can include one or more engines 120-1-120-5. The engines 120-1-120-5 may include routines, programs, objects, components, data structures, and the like, which perform particular tasks or implement particular abstract data types. Further, the engines 120-1-120-5 may be implemented in hardware, instructions executed by a processing unit, or by a combination thereof.

In an implementation, the engines 120-1-120-5 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 120-1-120-5 may perform different functionalities. The engines 120-1-120-5 may include a schema transformation engine 120-1, a schema merging engine 120-2, a schema intersection engine 120-3, a schema inference engine 120-4, and a schema annotation engine 120-5.

The schema transformation engine 120-1 may process and transform the data schema received from the source platforms 102, 104, 106. Particularly, the schema transformation engine 120-1 may process and transform the data schema into a schema compatible with the destination platform 108. In other words, the schema transformation engine 120-1 may process and transform the data schema from a raw form received from the source platforms 102, 104, 106 into a more natural descriptive form. In another example, the schema transformation engine 120-1 may also process and transform union of at least two data, intersection of at least two data, and the like into transformed forms. The schema transformation engine 120-1 may also store the transformed forms of the schema in the memory 122.

The schema merging engine 120-2 may merge the data schema for at least two data to form a union of the data schema. For instance, assume that a first data and a second data are received from the first source platform 102. The schema merging engine 120-2 may merge the first data and the second data to form a union of the first data and the second data. The union of the first data and the second data may include the first data, the second data, or the combination thereof. Further, in an example, the schema merging engine 120-2 may merge the transformed schema for at least two transformed data schema to form a merged transformed schema. For instance, assume that transformed schema of a first data is a first transformed schema and transformed schema of a second data is a second transformed schema. The schema merging engine 120-2 may merge the first transformed schema and the second transformed schema. In an example, the merging may be performed by a first model, such as a merging model.

The schema intersection engine 120-3 may combine at least two data to form an intersection of the at least two data. For instance, assume that a first data and a second data are received from the first source platform 102. The schema intersection engine 120-3 may combine the first data and the second data to form an intersection of the first data and the second data. The intersection of the first data and the second data corresponds to a data overlap between the first data and the second data.

The schema inference engine 120-4 may determine transformed forms of data with some transformations, instances of example data of unknown schema, and a model for determining the schema are provided. The schema annotation engine 120-5 may annotate the inferred schema inferred by the schema inference engine 120-4 with a transformed form of the data schema and the transformation used.

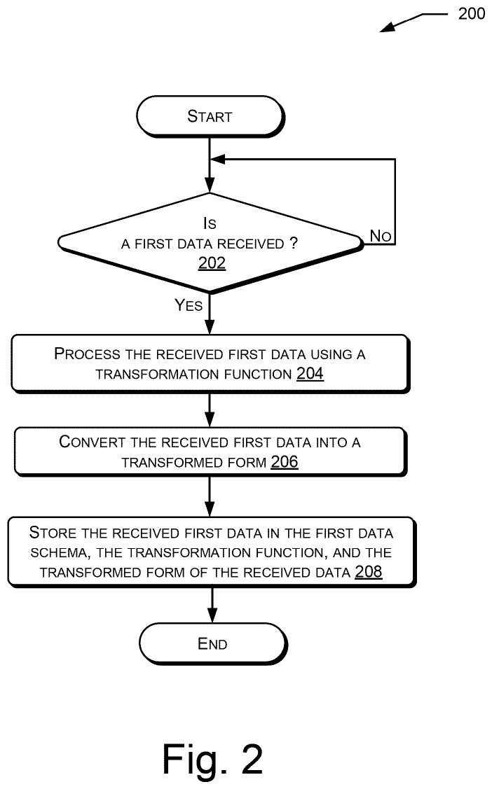

FIG. 2 illustrates a method 200 to transform data forms in schemas for data transfer between different platforms, according to an example implementation of the present subject matter. The order in which the method 200 is described is not intended to be construed as a limitation, and any number of the described method blocks may be combined in any order to implement the method 200, or an alternative method. Furthermore, the method 200 may be implemented by processor(s) or computing device(s) through any suitable hardware, non-transitory machine-readable instructions, or a combination thereof.

It may be understood that steps of the method 200 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 200 may be performed by the system 100. Particularly, the method 200 may be performed by the processing unit 120.

At step 202, it may be determined if the first data is received. The first data may be received, for example, from one of the first source platform 102, the second source platform 104, or the third source platform 106. Hereinafter, the first data may be explained with reference to being received by the first source platform 102. The first data may be in a first data schema. The first data schema may define the structure of the first data. For instance, the first data schema may specify the keywords and properties defining the first data, such as keys that are required and mandatory, keys that can exist, enforcing if every item in an array should be unique relative to one another, length of array, enumeration of definition for the items that can appear in an array, and the like. The first data schema may be in a raw form that corresponds to the first data having an additional structure. For instance, assume that an example value corresponding to the first data schema corresponding to multi-select fields is “first; second; fourth”. Here, the “;” is the additional structure. The additional structure may enable transformation of the first data into a format compatible with the destination platform, such as the destination platform 108.

If at step 202, if the first data is received, the method 200 may move to step 204. On the other hand, if the first data is not received, the method 200 may repeat the step 202 till the first data is received. At step 204, the received first data may be processed using a transformation function. The transformation function may be deterministic and pure function. The transformation function may be defined in a high-level programming language, such as Javascript, jq, python, and rego, c compiled to webassembly, java, haskell, and rust. The transformation function may be embedded in the first data schema received from the source platform, such as the source platform 102. For instance, if an example value corresponding to the first data schema is “first; second; fourth”, the split using “;” operator may be the transformation function. In an example, as described above, the transformation function may be s=>s.split (“;”) defined in Javascript. In another example, the transformation function may be “.|=sub(\“,\”;\“.\”)| try tonumber catch null” defined in jq. The transformation function defined above may transform a number encoded with comma as a decimal separator into a string into a more natural form thereof (an actual number).

At step 206, the received first data may be converted into a transformed form as a result of processing of the received first data. The transformed form of the first data may be in a first transformed schema that is compatible with the destination platform, such as the destination platform 108. For instance, as a result of transformation by split using “;” operator, the data schema may be transformed into an array of multi-select fields-[“first”, “second”, “fourth”], which is the first transformed schema.

At step 208, the received first data in the first data schema, the transformation function, and the transformed form of the received data in the first transformed data schema may be stored in the memory. For instance, “first;second;fourth”, the split using “;” operator, and [“first’, “second”, “fourth’] may be stored in the memory. The memory may correspond to the memory 122. The steps 204-208 may be performed by using the schema transformation engine 120-1.

FIG. 3 illustrates a method 300 to transform data forms in schemas for data transfer between different platforms, according to an example implementation of the present subject matter. The order in which the method 300 is described is not intended to be construed as a limitation, and any number of the described method blocks may be combined in any order to implement the method 300, or an alternative method. Furthermore, the method 300 may be implemented by processor(s) or computing device(s) through any suitable hardware, non-transitory machine-readable instructions, or a combination thereof.

It may be understood that steps of the method 300 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 300 may be performed by the system 100. Particularly, the method 300 may be performed by the processing unit 120.

Herein, a schema inference model is explained. The schema inference model may be used to manipulate the data schemas. The data schema may be inferred given some transformation, instances of example data of unknown data schema, and a model for determining the data schema of an instance of example data.

At step 302, it is determined if a second data is received. The second data may be received from the first source platform 102, the second source platform 104, or the third source platform 106. Hereinafter, the second data will be explained as being received from the first source platform 102. The second data may be in a second data schema. The second data schema may define the structure of the second data. For instance, the second data schema may specify the keywords and properties defining the second data, such as keys that are required and mandatory, keys that can exist, enforcing if every item in an array should be unique relative to one another, length of array, enumeration of definition for the items that can appear in an array, and the like. The second data schema may be in a raw form that corresponds to the second data having an additional structure. For instance, assume that an example value corresponding to the second data schema corresponding to multi-select fields is “fourth; fifth; seventh”. Here, the “;” is the additional structure. The additional structure may enable transformation of the second data into a format compatible with the destination platform, such as the destination platform 108.

At step 302, if the second data is received, the method 300 may proceed to step 304. However, if the second data is not received, the method 300 may repeat the step 302 till the second data is received.

At step 304, the transformation function may be applied on the second data to obtain a transformed form. The transformed form may be in a second transformed schema. The second transformed schema may be compatible with the second platform. For instance, if an example value corresponding to the second data schema is “fourth; fifth; seventh”, the split using “;” operator may be the transformation function that may be applied on the second data. The second transformed schema with the enums permitted value may be [“fourth”, “fifth”, “seventh”] as a result of applying the transformation function of split using “,” operator. The step 304 may be performed using the schema transformation engine 120-1.

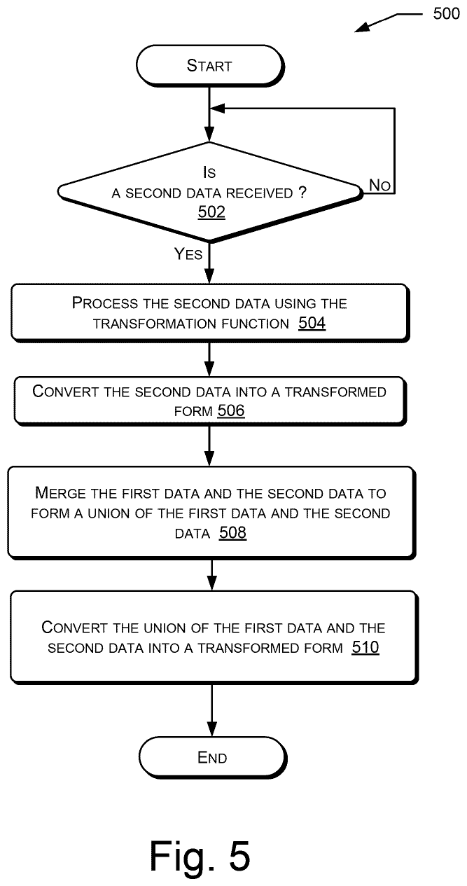

At step 306, the second transformed schema may be determined. For instance, the second transformed schema may be determined that schema of a given field is an array of possible fixed values. Further, at step 308, the first transformed schema may be merged with the second transformed schema to form a merged transformed schema. The first transformed schema may be the transformed schema formed at step 206, as explained with reference to FIG. 2. The merging may be performed, for example, using schema merging model, as will be explained with reference to FIG. 5. For instance, if an example value may be “first; second; fourth”. The first schema that admits such a value may be “string with transformation function of split (“;”) and transformed form of enum (“first”, “second”, “fourth”)” another example value be may “fourth; fifth; seventh”. The second data schema that admits such a value may be “string with transformation function of split (“;”) and transformed form of enum (“fourth”, “fifth”, “fourth”)”. The transformation function for the first data schema and the second data schema being split using “;” operator. In such a scenario, the merged transformed schema with the same transformation function but the enums permitted values set that is merged (set-unioned), such as [“first”, “second”, “fourth”, “fifth”, “seventh”]. The steps 306 and 308 may be performed using the schema inference engine 120-4.

At step 310, the second transformed schema may be annotated with the merged transformed schema and the transformation function. The step 310 may be performed using the schema annotation engine 120-5.

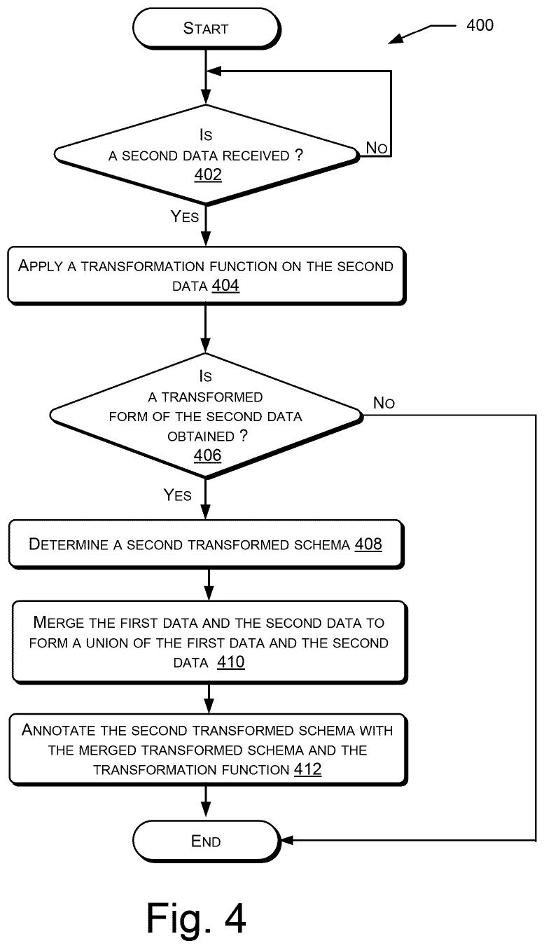

FIG. 4 illustrates a method 400 to transform data forms in schemas for data transfer between different platforms, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100. Particularly, the method 400 may be performed by the processing unit 120. The method 400 may be similar to method 300 but with additional method steps, as will be explained below:

At step 402, it is determined if a second data is received. The second data may be received from the first source platform 102, the second source platform 104, or the third source platform 106. Hereinafter, the second data will be explained as being received from the first source platform 102. The second data may be in a second data schema. The second data schema may define the structure of the second data. For instance, the second data schema may specify the keywords and properties defining the second data, such as keys that are required and mandatory, keys that can exist, enforcing if every item in an array should be unique relative to one another, length of array, enumeration of definition for the items that can appear in an array, and the like. The second data schema may be in a raw form that corresponds to the second data having an additional structure. The additional structure may enable transformation of the second data into a format compatible with the destination platform, such as the destination platform 108.

At step 402, if the second data is received, the method 400 may proceed to step 404. However, if the second data is not received, the method 400 may repeat the step 402 till the second data is received.

At step 404, the transformation function may be applied on the second data to obtain a transformed form. The transformed form may be in a second transformed schema. The second transformed schema may be compatible with the second platform. The transformation function may be embedded in the second data schema received from the source platform, such as the source platform 102. The step 404 may be performed using the schema transformation engine 120-1.

At step 406, it may be determined if the transformed form of the second data can be obtained. If it is determined that the transformed form of the second data is obtained, the method may proceed to step 408. If it is determined that the transformed form of the second data cannot be obtained, then the schema will not have a transformed form with that transformation function. The application of the transformation functions may fail if the second data is not similar to the first data.

At step 408, the second transformed schema may be determined. For instance, the second transformed schema may be determined that schema of a given field is an array of possible fixed values. Further, at step 410, the first transformed schema may be merged with the second transformed schema. The first transformed schema may be the transformed schema formed at step 206, as explained with reference to FIG. 2.

At step 410, the first transformed schema and the second transformed schema may be merged to form a merged transformed schema. The merging may be performed, for example, using schema merging model, as will be explained with reference to FIG. 5. The steps 406-410 may be performed using the schema inference engine 120-4. At step 412, the second transformed schema may be annotated with the merged transformed schema and the transformation function. The step 412 may be performed using the schema annotation engine 120-5.

FIG. 5 illustrates a method 500 to transform data forms in schemas for data transfer between different platforms, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100. Particularly, the method 500 may be performed by the processing unit 120. Herein, a first model, i.e., a schema merging model is explained. The schema merging model may be used to manipulate the data schemas.

At step 502, it is determined if a second data is received. The second data may be received from the first source platform 102, the second source platform 104, or the third source platform 106. Hereinafter, the second data will be explained as being received from the first source platform 102. The second data may be in a second data schema. The second data schema may define the structure of the second data. For instance, the second data schema may specify the keywords and properties defining the second data, such as keys that are required and mandatory, keys that can exist, enforcing if every item in an array should be unique relative to one another, length of array, enumeration of definition for the items that can appear in an array, and the like. The second data schema may be in a raw form that corresponds to the second data having an additional structure. For instance, assume that an example value corresponding to the second data schema corresponding to multi-select fields is “fourth; fifth; seventh”. Here, the “;” is the additional structure. The additional structure may enable transformation of the second data into a format compatible with the destination platform, such as the destination platform 108.

At step 502, if the second data is received, the method 500 may proceed to step 504. However, if the second data is not received, the method 500 may repeat the step 502 till the second data is received.

At step 504, the second data may be processed using the transformation function. Further, at step 506, the second data may be converted into a transformed form. The transformed form may be in a second transformed schema. The second transformed schema may be compatible with the second platform. If an example value corresponding to the second data schema is “fourth; fifth; seventh”, the split using “,” operator may be the transformation function that may be applied on the second data. The second transformed schema may be [“fourth”, “fifth”, “seventh”] as a result of converting the second data the transformation function of split using “,” operator. Similarly, as explained with reference to FIG. 2, the first transformed schema may be [“first”, “second”, “fourth”]. The union of the first transformed schema and the second transformed schema may be [“first”, “second”, “fourth”, “fifth”, ‘seventh”]. The steps 504 and 506 may be performed using the schema transformation engine 120-1.

At step 508, the first data and the second data may be merged to form a union of the first data and the second data. The union of the first data and the second data may correspond to data including the first data, the second data, or a combination thereof. For instance, the union of the first data and the second data may be, for example, “first; second; fourth; fifth; seventh”.

At step 510, the union of the first data and the second data may be converted into a transformed form. The transformed form may be in a third transformed schema. The third transformed schema may be compatible with the destination platform. For instance, “first;second;fourth;fifth;seventh” may be converted into a transformed form by split using “;” operator. Accordingly, the third transformed schema may be [“first”, “second”, “fourth”, “fifth”, “seventh”.]. The third transformed schema may be a union of the first transformed schema and the second transformed schema, as explained with reference to step 504. The union of the first transformed schema and the second transformed schema corresponding to the first transformed schema, the second transformed schema, or combination thereof. For instance, assume that values in set A are described by data schema SA, and values in set B are described by data schema SB. Further, assume that SA and SB include transformed forms with the same transformation function. Combined schema SAUB describing union of set A and set B may include a transformed form with the same transformation function. The transformed schema may be the union of the two transformed schemas, as explained above. The steps 508 and 510 may be performed using the schema merging engine 120-2.

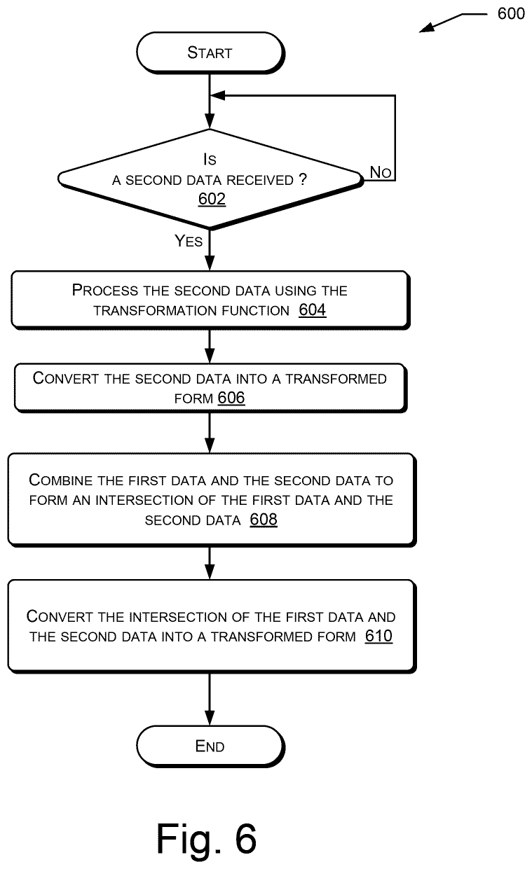

FIG. 6 illustrates a method 600 to transform data forms in schemas for data transfer between different platforms, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 100. Particularly, the method 600 may be performed by the processing unit 120. Herein, a schema intersection model is explained. The schema intersection model may be used to manipulate the data schemas.

At step 602, it is determined if a second data is received. The second data may be received from the first source platform 102, the second source platform 104, or the third source platform 106. Hereinafter, the second data will be explained as being received from the first source platform 102. The second data may be in a second data schema. The second data schema may define the structure of the second data. For instance, the second data schema may specify the keywords and properties defining the second data, such as keys that are required and mandatory, keys that can exist, enforcing if every item in an array should be unique relative to one another, length of array, enumeration of definition for the items that can appear in an array, and the like. The second data schema may be in a raw form that corresponds to the second data having an additional structure. For instance, assume that an example value corresponding to the second data schema corresponding to multi-select fields is “fourth; fifth; seventh”. Here, the “;” is the additional structure. The additional structure may enable transformation of the second data into a format compatible with the destination platform, such as the destination platform 108.

At step 602, if the second data is received, the method 600 may proceed to step 604. However, if the second data is not received, the method 500 may repeat the step 602 till the second data is received.

At step 604, the second data may be processed using the transformation function. Further, at step 606, the second data may be converted into a transformed form. The transformation form may be in a second transformed schema. The second transformed schema may be compatible with the second platform. If an example value corresponding to the second data schema is “second;fourth;fifth”, the split using “;” operator may be the transformation function that may be applied on the second data. The second transformed schema may be [“second”, “fourth”, “fifth”] as a result of converting the second data the transformation function of split using “;” operator. Similarly, as explained with reference to FIG. 2, the first transformed schema may be [“first”, “second”, “fourth”]. An intersection of the first transformed schema and the second transformed schema may be [“second”, “fourth”], i.e., values common to both the first transformed schema and the second transformed schema. The steps 604 and 606 may be performed using the schema transformation engine 120-1.

At step 608, the first data and the second data may be combined to form an intersection of the first data and the second data. The intersection of the first data and the second data may correspond to data overlap between the first data and the second data. For instance, the intersection of the first data and the second data may be, for example, “second; fourth”.

At step 610, the intersection of the first data and the second data may be converted into a transformed form. The transformed form may be in a fourth transformed schema. The fourth transformed schema may be compatible with the destination platform. For instance, “second; fourth” may be converted into a transformed form by split using “;” operator. Accordingly, the fourth transformed schema may be [“second”, “fourth”]. The third transformed schema may be an intersection of the first transformed schema and the second transformed schema, as explained with reference to step 604. The intersection of the first transformed schema and the second transformed schema may correspond to data overlap between the first transformed schema and the second transformed schema. For instance, assume that values in set A are described by data schema SA and values in set B are described by data schema SB. Further, assume that SA and SB include a transformed form. The intersection data schema SANB describing intersection of set A and set B may also have the transformed form. If SA also includes a transformed form with the same transformation, the transferred form in the intersection schema may have an output described by the intersection of the output schemas of the original forms, as explained above. The steps 608 and 610 may be performed using the schema intersection engine 120-3.

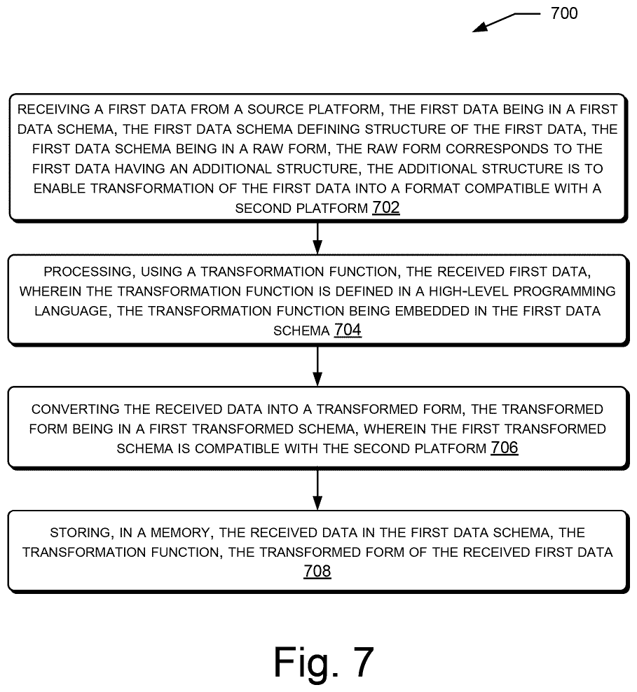

FIG. 7 illustrates a method 700 to transform data forms in schemas for data transfer between different platforms, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 700 may be performed by the system 100. Particularly, the method 700 may be performed by the processing unit 120.

At step 702, a first data may be received from a source platform. The first data may be in a first data schema. The first data schema may define structure of the first data. The first data schema may be in a raw form that corresponds to the first data having an additional structure. The additional structure may enable transformation of the first data into a format compatible with a second platform. The first platform may be, for example, the first source platform 102, the second source platform 104, or the third source platform 106. The second platform may be, for example, the destination platform 108.

At step 704, the received first data may be processed using a transformation function. The transformation function may be defined in a high-level programming language. The transformation function may be embedded in the first data schema. The transformation function may correspond to a deterministic function. At step 706, the received first data may be converted into a transformed form. The transformed form may be in a first transformed schema. The first transformed schema may be compatible with the second platform. At step 708, the received first data in the first data schema, the transformation function, and the transformed form of the received first data may be stored in a memory. The memory may correspond to the memory 122.

In an example, the method 700 includes receiving a second data from the source platform. The second data may be in a second data schema. The second data schema may define structure of the second data. The second data schema may be in a raw form. The raw form corresponds to the second data having an additional structure. The additional structure may enable transformation of the second data into a format compatible with the second platform. Further, the method 700 includes applying the transformation function on the second data to obtain a transformed form. The transformed form may be in a second transformed schema that is compatible with the second platform. The second data may be similar to the first data. Further, the second transformed schema may be determined. The first transformed schema may be merged with the second transformed schema to obtain a merged. The merging may be performed using a first model, such as a schema merging model. Further, the second transformed schema may be annotated with the merged transformed schema and the transformation function. The merged transformed schema may correspond to a union of the first transformed schema and the second transformed schema. The union of the first transformed schema and the second transformed schema may correspond to the first transformed schema, the second transformed schema, or combination thereof.

In another example, a second data from the source platform may be received. The second data may be in a second data schema. The second data schema may define structure of the second data. The second data schema may be in a raw form that corresponds to the second data having an additional structure. The additional structure may enable transformation of the second data into a format compatible with the second platform. The transformation function may be applied on the second data. A transformed form of the second data may not be obtained if the application of the transformation function fails. The application of the transformation function may fail if the second data is not similar to the first data.

In yet another example, a second data may be received from the source platform. The second data may be in a second data schema. The second data schema may define structure of the second data. The second data schema may be in a raw form that corresponds to the second data having an additional structure. The additional structure may enable transformation of the second data into a format compatible with the second platform The second data may be processed using the transformation function. The second data may be converted into a transformed form. The transformed form may be in a second transformed schema. The second transformed schema may be compatible with the second platform.

The first data and second data may be merged to form a union of the first data and the second data. The union of the first data and the second data may correspond to data including the first data, the second data, or combination thereof. The union of the first data and the second data may be converted into a transformed form. The transformed form may be in a third transformed schema that is compatible with the second platform. The third transformed schema may be a union of the first transformed schema and the second transformed schema. The union of the first transformed schema and the second transformed schema may correspond to the first transformed schema, the second transformed schema, or combination thereof.

In another example, a second data may be received from the source platform. The second data may be in a second data schema. The second data schema may define structure of the second data. The second data schema may be in a raw form that corresponds to the second data having an additional structure. The additional structure may enable transformation of the second data into a format compatible with the second platform. The second data may be processed using the transformation function. The second data may be converted into a transformed form. The transformed form may be in a second transformed schema that is compatible with the second platform.

The first data and second data may be combined to form an intersection of the first data and the second data. The intersection of the first data and the second data may correspond to data overlap between the first data and the second data. The intersection of the first data and the second data may be converted into a transformed form. The transformed form may be in a fourth transformed schema. The fourth transformed schema may be compatible with the second platform. The fourth transformed schema may be an intersection of the first transformed schema and the second transformed schema. The intersection of the first transformed schema and the second transformed schema may correspond to data overlap between the first transformed schema and the second transformed schema.

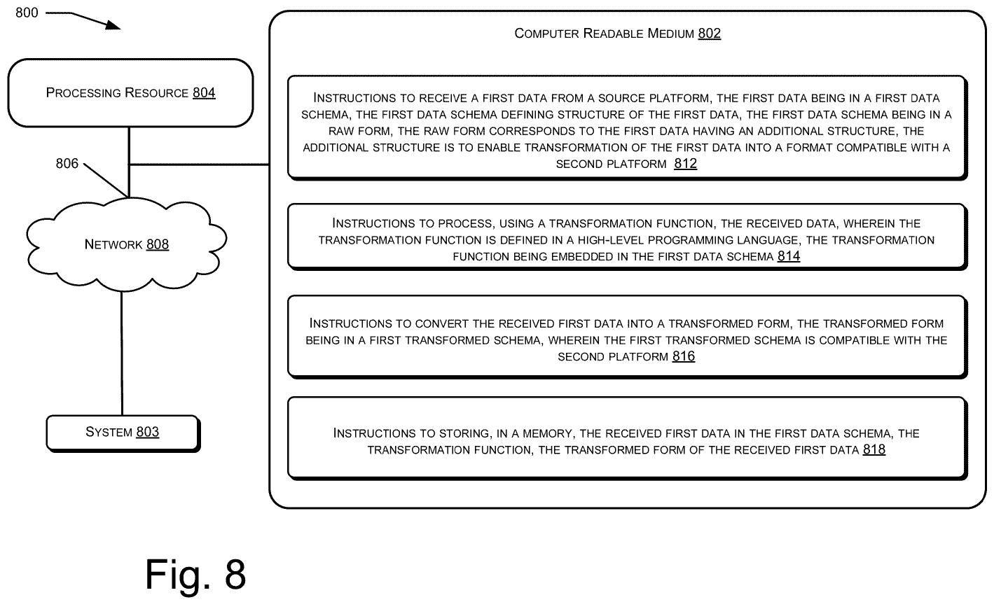

FIG. 8 illustrates a computing environment 800, implementing a non-transitory computer-readable medium for transformation of data forms in schemas for data transfer between different platforms, according to an example implementation of the present subject matter. In an example, the non-transitory computer-readable medium 802 may be utilized by the system 803. The system 803 may correspond to the system 100. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The non-transitory computer-readable medium 802 may be, for example, an internal memory device of the system 803 or an external memory device. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions to transform data forms in schemas for data transfer between different platforms. The set of computer-readable instructions can be accessed by the processing resource 804 through the communication link 806.

Referring to FIG. 8, in an example, the non-transitory computer-readable medium 802 includes instructions 812 to receive a first data from a source platform. The first data may be in a first data schema. The first data schema may define structure of the first data. The first data schema may be in a raw form that corresponds to the first data having an additional structure. The additional structure may enable transformation of the first data into a format compatible with a second platform. The source platform may be, for example, the first source platform 102, the second source platform 104, or the third source platform 106. The second platform may be, for example, the destination platform 108.

The non-transitory computer-readable medium 802 includes instructions 814 to process, using a transformation function, the received first data. The transformation function may be defined in a high-level programming language. The high-level programming language may be, for example, Javascript, jq, python, rego, haskell, c compiled to webassembly, java, haskell, and rust. The transformation function may be embedded in the first data schema.

The non-transitory computer-readable medium 802 includes instructions 816 to convert the received first data into a transformed form. The transformed form may be in a first transformed schema. The first transformed schema may be compatible with the second platform. The non-transitory computer-readable medium 802 includes instructions 818 to store, in a memory, the received first data in the first data schema, the transformation function, the transformed form of the received first data. The memory may correspond to the memory 122.

The non-transitory computer-readable medium 802 includes instructions to receive a second data from the source platform. The second data may be in a second data schema. The second data schema may define structure of the second data. The second data schema may be in a raw form. The raw form may correspond to the second data having an additional structure. The additional structure may enable transformation of the second data into a format compatible with the second platform. The non-transitory computer-readable medium 802 includes instructions to apply the transformation function on the second data to obtain a transformed form. The transformed form may be in a second transformed schema. The second transformed schema may be compatible with the second platform. The second data may be similar to the first data.

The non-transitory computer-readable medium 802 includes instructions to determine the second transformed schema and merge, using a first model, the first transformed schema with the second transformed schema to obtain a merged transformed schema. The first model may be, for example, schema merging model. The non-transitory computer-readable medium 802 includes instructions to annotate the second transformed schema with the merged transformed schema and the transformation function.

The non-transitory computer-readable medium 802 includes instructions to receive a second data from the source platform. The second data being in a second data schema. The second data schema may define structure of the second data. The second data schema may be in a raw form that corresponds to the second data having an additional structure. The additional structure may enable transformation of the second data into a format compatible with the second platform. The transformation function may be applied on the second data. A transformed form of the second data may not be obtained if the application of the transformation function fails. The application of the transformation function may fail if the second data is not similar to the first data.

The non-transitory computer-readable medium 802 includes instructions to receive a second data from the source platform. The second data may be in a second data schema. The second data schema may define structure of the second data. The second data schema may be in a raw form that corresponds to the second data having an additional structure. The additional structure may enable transformation of the second data into a format compatible with the second platform. The second data may be processed using the transformation function.

The non-transitory computer-readable medium 802 includes instructions to convert the second data into a transformed form. The transformed form may be in a second transformed schema. The second transformed schema may be compatible with the second platform. The non-transitory computer-readable medium 802 includes instructions to merge the first data and second data to form a union of the first data and the second data. The union of the first data and the second data may correspond to data including the first data, the second data, or combination thereof.

The union of the first data and the second data may be converted into a transformed form. The transformed form may be in a third transformed schema. The third transformed schema may be compatible with the second platform. The third transformed schema may be a union of the first transformed schema and the second transformed schema. The union of the first transformed schema and the second transformed schema may correspond to the first transformed schema, the second transformed schema, or combination thereof.

In another example, the non-transitory computer-readable medium 802 includes instructions to receive a second data from the source platform. The second data may be in a second data schema. The second data schema may define structure of the second data. The second data schema may be in a raw form. The raw form may correspond to the second data having an additional structure. The additional structure may enable transformation of the second data into a format compatible with the second platform. The second data may be processed using the transformation function. The second data may be converted into a transformed form. The transformed form may be in a second transformed schema. The second transformed schema may be compatible with the second platform.

The non-transitory computer-readable medium 802 includes instructions to combine the first data and second data to form an intersection of the first data and the second data. The intersection of the first data and the second data may correspond to data overlap between the first data and the second data. The intersection of the first data and the second data may be converted into a transformed form. The transformed form may be in a fourth transformed schema, which is compatible with the second platform. The fourth transformed schema may be an intersection of the first transformed schema and the second transformed schema. The intersection of the first transformed schema and the second transformed schema corresponding to data overlap between the first transformed schema and the second transformed schema.

With the present subject matter, data is transformed from a raw format into a more natural format that is compatible with a destination platform into which the data has to be integrated into. Further, with the present subject matter, data integration from a source platform into a destination platform is easier and simpler. Even if data may have to be integrated from a plurality of source platforms into a destination platform, the present subject matter enables easy, efficient, and simpler integration of data. In the present subject matter, the transformed schemas are in natural form and are in descriptive language. In other words, in the present subject matter, the schemas are self-describing with no special format names. Accordingly, with the present subject matter, the schema of the source platforms that is being described by transformed forms are more granularly described. The present subject matter enables actionable transformation to transform the received data from the source platforms. Further, the present subject matter enables to recover validation by transforming the received data into a transformed form and validating output of the received data against schema of the output in the transformed form. The present subject matter is actionable without human intervention or Artificial intelligence intervention for the data integration into a destination platform.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

1. A system for transforming data forms in schemas for data transfer between different platforms, the system comprising:
a memory:
a processing unit coupled to the memory, wherein the processing unit is to:
receive a first data from a source platform, the first data being in a first data schema, the first data schema defining structure of the first data, the first data schema being in a raw form, the raw form corresponds to the first data having an additional structure, wherein the additional structure is to enable transformation of the first data into a format compatible with a second platform, wherein each of the first and second platforms comprise a computing system that sends or receives data in a data format that is not natively compatible with at least one other computing system;
process, using a transformation function, the received first data, wherein the transformation function is defined in a high-level programming language, the transformation function being embedded in the first data schema;
convert the received first data into a transformed form, the transformed form being in a first transformed schema, wherein the first transformed schema is compatible with the second platform; and
storing, in the memory, the received first data in the first data schema, the transformation function, the transformed form of the received first data.

2. The system of claim 1, wherein the processing unit is to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform;
apply the transformation function on the second data to obtain a transformed form, the transformed form being in a second transformed schema, wherein the second transformed schema is compatible with the second platform, wherein the second data is similar to the first data;
determine the second transformed schema;
merge, using a first model, the first transformed schema with the second transformed schema to obtain a merged transformed schema; and
annotate the second transformed schema with the merged transformed schema and the transformation function.

3. The system of claim 1, wherein the processing unit is to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
apply the transformation function on the second data, wherein a transformed form of the second data is not obtained if the application of the transformation function fails, wherein the application of the transformation function fails is to fail if the second data is not similar to the first data.

4. The system of claim 1, wherein the processing unit is to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
process, using the transformation function, the second data;
convert the second data into a transformed form, the transformed form being in a second transformed schema, wherein the second transformed schema is compatible with the second platform;
merge the first data and second data to form a union of the first data and the second data, wherein the union of the first data and the second data corresponds to data including the first data, the second data, or combination thereof; and
convert the union of the first data and the second data into a transformed form, the transformed form being in a third transformed schema, wherein the third transformed schema being compatible with the second platform, wherein the third transformed schema is a union of the first transformed schema and the second transformed schema, the union of the first transformed schema and the second transformed schema corresponding to the first transformed schema, the second transformed schema, or combination thereof.

5. The system of claim 1, wherein the processing unit is to:
receive a second data from the source platform, the second data being in a second data schema, the second data schema defining structure of the second data, the second data schema being in a raw form, the raw form corresponds to the second data having an additional structure making the second data incompatible with the second platform;
process, using the transformation function, the second data;
convert the second data into a transformed form, the transformed form being in a second transformed schema, wherein the second transformed schema is compatible with the second platform;
combine the first data and second data to form an intersection of the first data and the second data, wherein the intersection of the first data and the second data corresponds to data overlap between the first data and the second data; and
convert the intersection of the first data and the second data into a transformed form, the transformed form being in a fourth transformed schema, wherein the fourth transformed schema is compatible with the second platform, wherein the fourth transformed schema is an intersection of the first transformed schema and the second transformed schema, the intersection of the first transformed schema and the second transformed schema corresponding to data overlap between the first transformed schema and the second transformed schema.

6. The system of claim 1, wherein the high-level programming language is one of: Javascript, jq, python, rego, c compiled to webassembly, java, haskell, and rust.

7. The system of claim 1, wherein the transformation function corresponds to a deterministic function.

8. A method for transforming data forms in schemas for data transfer between different platforms, the method comprising:
receiving a first data from a source platform, the first data being in a first data schema, the first data schema defining structure of the first data, the first data schema being in a raw form, the raw form corresponds to the first data having an additional structure, wherein the additional structure is to enable transformation of the first data into a format compatible with a second platform, wherein each of the first and second platforms comprise a computing system that sends or receives data in a data format that is not natively compatible with at least one other computing system;
processing, using a transformation function, the received first data, wherein the transformation function is defined in a high-level programming language, the transformation function being embedded in the first data schema;
converting the received first data into a transformed form, the transformed form being in a first transformed schema, wherein the first transformed schema is compatible with the second platform; and
storing, in a memory, the received first data in the first data schema, the transformation function, the transformed form of the received first data.

9. The method of claim 8, comprising:
receiving a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform;
applying the transformation function on the second data to obtain a transformed form, the transformed form being in a second transformed schema, wherein the second transformed schema is compatible with the second platform, wherein the second data is similar to the first data;
determining the second transformed schema;
merging, using a first model, the first transformed schema with the second transformed schema to obtain a merged transformed schema; and
annotating the second transformed schema with the merged transformed schema and the transformation function.

10. The method of claim 9, wherein the merged transformed schema corresponds to a union of the first transformed schema and the second transformed schema, the union of the first transformed schema and the second transformed schema corresponding to the first transformed schema, the second transformed schema, or combination thereof.

11. The method of claim 8, comprising:
receiving a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
applying the transformation function on the second data, wherein a transformed form of the second data is not obtained if the application of the transformation function fails, wherein the application of the transformation function is to fail fails if the second data is not similar to the first data.

12. The method of claim 8, comprising:
receiving a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
processing, using the transformation function, the second data;
converting the second data into a transformed form, the transformed form being in a second transformed schema, wherein the second transformed schema is compatible with the second platform;
merging the first data and second data to form a union of the first data and the second data, wherein the union of the first data and the second data corresponds to data including the first data, the second data, or combination thereof; and
converting the union of the first data and the second data into a transformed form, the transformed form being in a third transformed schema, wherein the third transformed schema being compatible with the second platform, wherein the third transformed schema is a union of the first transformed schema and the second transformed schema, the union of the first transformed schema and the second transformed schema corresponding to the first transformed schema, the second transformed schema, or combination thereof.

13. The method of claim 8, comprising:
receiving a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform;
processing, using the transformation function, the second data;
converting the second data into a transformed form, the transformed form being in a second transformed schema, wherein the second transformed schema is compatible with the second platform;
combining the first data and second data to form an intersection of the first data and the second data, wherein the intersection of the first data and the second data corresponds to data overlap between the first data and the second data; and
converting the intersection of the first data and the second data into a transformed form, the transformed form being in a fourth transformed schema, wherein the fourth transformed schema is compatible with the second platform, wherein the fourth transformed schema is an intersection of the first transformed schema and the second transformed schema, the intersection of the first transformed schema and the second transformed schema corresponding to data overlap between the first transformed schema and the second transformed schema.

14. The method of claim 8, wherein the transformation function corresponds to a deterministic function.

15. A non-transitory computer-readable medium comprising instructions for transforming data forms in schemas for data transfer between different platforms, the instructions being executable by a processing resource to:
receive a first data from a source platform, the first data being in a first data schema, the first data schema defining structure of the first data, the first data schema being in a raw form, the raw form corresponds to the first data having an additional structure, wherein the additional structure is to enable transformation of the first data into a format compatible with a second platform, wherein each of the first and second platforms comprise a computing system that sends or receives data in a data format that is not natively compatible with at least one other computing system;
process, using a transformation function, the received first data, wherein the transformation function is defined in a high-level programming language, the transformation function being embedded in the first data schema;
convert the received first data into a transformed form, the transformed form being in a first transformed schema, wherein the first transformed schema is compatible with the second platform; and
storing, in a memory, the received first data in the first data schema, the transformation function, the transformed form of the received first data.

16. The non-transitory computer-readable medium of claim 15, the instructions being executable by a processing resource to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform;
apply the transformation function on the second data to obtain a transformed form, the transformed form being in a second transformed schema, wherein the second transformed schema is compatible with the second platform, wherein the second data is similar to the first data;
determine the second transformed schema;
merge, using a first model, the first transformed schema with the second transformed schema to obtain a merged transformed schema; and
annotate the second transformed schema with the merged transformed schema and the transformation function.

17. The non-transitory computer-readable medium of claim 15, the instructions being executable by a processing resource to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
apply the transformation function on the second data, wherein a transformed form of the second data is not obtained if the application of the transformation function fails, wherein the application of the transformation function fails is to fail if the second data is not similar to the first data.

18. The non-transitory computer-readable medium of claim 15, the instructions being executable by a processing resource to:
receive a second data from the source platform, the second data being in a second data schema, the second data schema defining structure of the second data, the second data schema being in a raw form, the raw form corresponds to the second data having an additional structure, wherein the additional structure is to enable transformation of the second data into a format compatible with the second platform; and
process, using the transformation function, the second data;
convert the second data into a transformed form, the transformed form being in a second transformed schema, wherein the second transformed schema is compatible with the second platform;
merge the first data and second data to form a union of the first data and the second data, wherein the union of the first data and the second data corresponds to data including the first data, the second data, or combination thereof; and
convert the union of the first data and the second data into a transformed form, the transformed form being in a third transformed schema, wherein the third transformed schema being compatible with the second platform, wherein the third transformed schema is a union of the first transformed schema and the second transformed schema, the union of the first transformed schema and the second transformed schema corresponding to the first transformed schema, the second transformed schema, or combination thereof.

19. The non-transitory computer-readable medium of claim 15, the instructions being executable by a processing resource to:
receive a second data from the source platform, the second data being in a second data schema, the second data schema defining structure of the second data, the second data schema being in a raw form, the raw form corresponds to the second data having an additional structure wherein the additional structure is to enable transformation of the second data into a format compatible with the second platform;
process, using the transformation function, the second data;
convert the second data into a transformed form, the transformed form being in a second transformed schema, wherein the second transformed schema is compatible with the second platform;
combine the first data and second data to form an intersection of the first data and the second data, wherein the intersection of the first data and the second data corresponds to data overlap between the first data and the second data; and
convert the intersection of the first data and the second data into a transformed form, the transformed form being in a fourth transformed schema, wherein the fourth transformed schema is compatible with the second platform, wherein the fourth transformed schema is an intersection of the first transformed schema and the second transformed schema, the intersection of the first transformed schema and the second transformed schema corresponding to data overlap between the first transformed schema and the second transformed schema.

20. The non-transitory computer-readable medium of claim 15, wherein the high-level programming language is one of: Javascript, jq, python, rego, c compiled to webassembly, java, haskell, and rust.
